(19) United States
(12) Patent Application Publication
(10) Pub. No.: US 2002/0003797 A1
(43) Pub. Date: Jan. 10, 2002

(54) Data structures and method for administering path information and changes thereto in an MPLS network

(76) Inventor: Mathias Rautenberg, Eichenau (DE)

Correspondence Address: STAAS & HALSEY LLP, 700 11TH STREET, NW, SUITE 500, WASHINGTON, DC, 20001, US

(21) Appl. No.: 09/876,149

(22) Filed: Jun. 8, 2001

(30) Foreign Application Priority Data
Jun. 8, 2000 (EP) 00112299.3

(51) Int. Cl. H04L 12/56

(52) U.S. Cl. 370/389; 370/392

(57) ABSTRACT

A computer assisted method processes routing/forwarding information in a network by accessing at least one first data structure having at least one entity per object in addition to routing/forwarding information and by accessing a second data structure, having at least one entity per object in addition to the routing/forwarding information. Each object to be processed in the first and second data structures is accessed using the additional entities. The routing/forwarding information is processed using standardized algorithms optimized in terms of timing.

### CROSS REFERENCE TO RELATED APPLICATIONS

This application is based on and hereby claims priority to European Application No. 00112299.3 filed on Jun. 8, 2000 in the European Patent Office, the contents of which are hereby incorporated by reference.

### BACKGROUND OF THE INVENTION

The invention relates to a data structure for use when processing routing and/or forwarding information in a network, and to a computer assisted method for processing forwarding and/or routing information in a network by accessing at least one first and a second data structure.

The term MultiProtocol Label Switching network (MPLS network for short below) refers to a network technology which is very new and for which commercial implementations have been available on the market only since the end of 1999. This technology provides a switching mechanism which is based on the use of “labels”.

As normal, customary mode, MPLS uses layer 3 (L3) routing (IP routing, such as IPx, for example Ipv4 or Ipv6) at all nodes in order to determine the chosen path. However, MPLS is compatible with a multiplicity of other routing protocols (for example OSPF, BCP, RIP or others) and, in principle, is executed independently of the underlying routing protocols.

MPLS networks are implemented for a very wide variety of link level techniques, such as packet-over-sonet, frame relay, ATM, Ethernet, token ring and others.

The “MP” (MultiProtocol) part of MPLS refers to this fact, namely that these networks support various protocols.

The “LS” (Label Switching) part of MPLS refers to the circumstance that MPLS networks support simple and integrated forwarding of a plurality of packets, so that particular packets are forwarded as one unit and in so doing ensure that a particular packet runs on a particular path. “LS” refers, in particular, to the circumstance that “Label Switched Paths” (LSP) are switched. On these paths, various data streams are then combined as being associated with a common label, in order that they may be switched on a common path (LSP).

When a packet enters an MPLS domain, each packet is allocated a label and is then forwarded on the path.

For any Label Switched Router (LSR) on the path, only the label is then used in order to forward the packet to the next hop. In this context, the labels have a strictly local significance between respectively adjacent nodes. They are thus used to create a simplified forwarding paradigm. This is ensured in that the device which uses the labels to forward packets forwards all packets having the same label in the same way. This greatly simplifies forwarding, since the label serves as an abbreviation or indication for the respective forwarding decision of a router (also referred to herein as a “node”).

The essence of the underlying forwarding mechanism is that the input label is checked and then the output label, the port and possibly other information are determined.

For the MPLS networks, a “Forwarding Equivalence Class” (FEC for short below) is defined which is used to denote a group of IP packets forwarded in the same way and thus having the same forwarding information. The label is used as a designation for identifying the respective FEC.

A packet is usually associated with an FEC on the basis of its network layer destination address. The label can never be a full encoding of this address, however. For forwarding, various packets depicted in the same FEC can be distinguished, however.

If a packet is now in transit from one router to the next in a (conventional, not based on label forwarding) network, each router makes a separate forwarding decision for the respective packet. Each router thus analyzes the header of the packet, and a network layer routing algorithm runs on each router. Each router thus individually selects—on the basis of its previous analysis and the result of the algorithm—the next hop for the packet. In the case of conventional IP forwarding, a packet is repeatedly associated with an FEC for each hop. This increases the administration complexity and results in redundant computation work.

By contrast, in MPLS networks, this association is made only once, namely when a node enters the network. Upon successive hops, other routers therefore no longer carry out further analysis of the header. The whole of forwarding is controlled by the label. In this context, the label is used as an index in a table and specifies the next hop and a new label.

If networks and, in particular, MPLS networks with the use of FECs and labels are now taken as a general basis, then it becomes clear that forwarding generally, but particularly when having recourse to labels (which abbreviate analysis), entails an additional request. Although the labels serve to optimize network operation and provide faster switching, they require additional support for this speed, by administration algorithms optimized in terms of timing. This is because the forwarding information naturally needs to be organized, administered and maintained in order to ensure fault-free and secure network operation. Particularly when paths change as a result of the failure of a particular router, for example, all the path information needs to be consistently retraced for the entire network.

That is to say, the data traffic which previously ran via a particular node in the network now needs to be diverted via another. To this end, all the data records which contained the previous node need to be consistently converted to the new node. This diversion needs to be made uniformly in the entire network in order to prevent erroneous attributions and erroneous transfers. This makes it absolutely necessary to find all the data records which contained the previous node as an entry as quickly as possible in order to be able to modify this entry. Particularly in large networks whose routers send the data traffic via several thousand paths, a method is needed which permits path information and changes, particularly a change in the IP forwarding table, to be found and administered as efficiently as possible. Such a method has not been known to date. Previously, in MPLS networks, an extensive and time-consuming search in a plurality of data structures has been necessary using specific and complex search algorithms.

If other approaches are used, for example administration of the relevant information for signaling method No 7 in today's ISDN, then this also does not provide the person skilled in the art with any proposals for a solution to this problem situation. With this signaling method, inverted lists are used. In this context, a destination (or in this case node) is allocated all the links which refer to it. With a relatively large number of links, this method quickly exceeds the potential memory space and results in the system being overloaded. Particularly in MPLS networks, an increased number of references must be expected, since only the labels and not the entire header are forwarded for a packet. On that basis, specifically for MPLS networks, a corresponding solution to the above problem situation is not appropriate.

### SUMMARY OF THE INVENTION

In response to the difficulties and problems discussed above, the present inventor proposes providing a suitable data structure for the relevant information which permits the information to be accessed in a manner optimized in terms of timing and resources. The present inventor also proposes a method which permits efficient administration of path information and changes thereto in a network, in particular an efficient search and/or change for appropriate objects in the respective data structures.

According to one implementation, first and second data structures each have at least one additional entity per object in addition to the information, so that the information in the first and second data structures is processed using the additional entities.

According to another implementation, a computer assisted method for processing forwarding and/or routing information in a network by accessing at least one first data structure and a second data structure which each have at least one additional entity per object in addition to the information, having the following steps:

a) the object(s) to be processed in the first and second data structures is/are accessed at least to some extent using the additional entities,

b) the information is processed using standardized algorithms optimized in terms of timing.

Selected embodiments of invention afford the significant advantage in that the specific design of the data structures allows standard list algorithms to be used which were previously not able to be applied. These also reduce the administration and access times.

In one embodiment of the invention, the method organizes path changes or path administration, with the paths being based on some explicit routing. Alternatively, hop-to-hop routing can be used.

Another, embodiment extends the conventional first data structure—the Label Information Base (LIB for short below)—by two pointers. This produces the advantage, which proves to be very significant in practice, that the search for an entry in a list can be performed very much more quickly and that the administration complexity for changes to the path, in particular deletion and insertion of a router (node), is significantly reduced. In this case, the complexity (memory space) has a very positive ratio to the success obtained.

Alternatively, this given first data structure can also be extended by just one entity, namely one pointer, however, although this slows down the method somewhat.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a schematic illustration of diversion from one node to another; and

FIG. 2 shows a schematic illustration of a first and a second data structure according to a preferred embodiment of the invention.

### DESCRIPTION OF THE PREFERRED EMBODIMENTS

Reference will now be made in detail to the preferred embodiments of the present invention, examples of which are illustrated in the accompanying drawings, wherein like reference numerals refer to like elements throughout.

By way of introduction, the text below gives a brief presentation of the general design of the first and second data structures A′, B′ proposed by the inventors and of the extensions to the conventional first and second data structures A, B, with illustrative reference to an MPLS network.

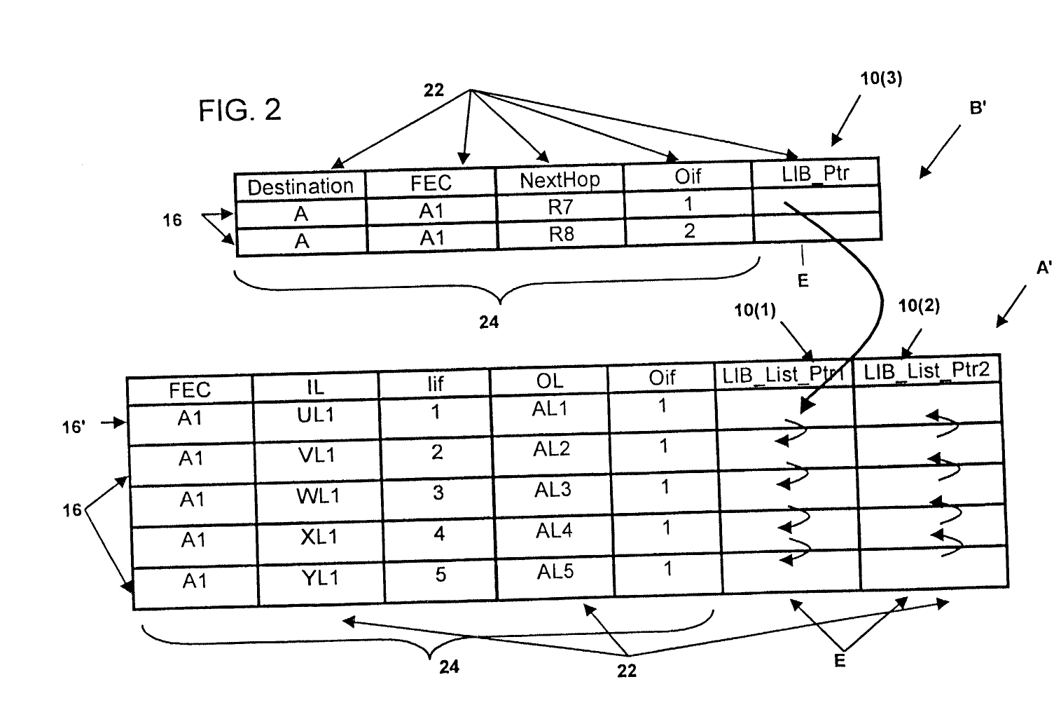

The design of the first data structure A′ and of the second data structure B′ is explained with reference to FIG. 2. In this exemplary embodiment, in addition to the information for forwarding, data structure A′ comprises two pointers: a first pointer 10(1) and a second pointer 10(2) for each object 16. In parallel with this, besides the information 24 for forwarding, the data structure B′ comprises a third pointer 10(3) per object 16.

FIG. 2 also indirectly shows the design of the given first data structure A and of the given second data structure B, which are known previously and are used in the prior art: if the last entry 22 in the data structure B′, namely the pointer 10(3), is dispensed with, then the given second data structure B is obtained. If the last two entries 22 in the data structure A′, namely the pointers 10(1) and 10(2), are dispensed with, then the given first data structure A is obtained.

To date, the data relevant to forwarding have been stored in the given first and second data structures A, B—in the form of a list in each case.

A list “Label Information Base” (LIB for short below) exists for each router in the network and in this context comprises entries having the following information: indication of a Forwarding Equivalence Class (FEC for short below), input label (IL), input interface (Iif), output label (OL) and output interface (Oif).

The given first data structure A thus comprises objects 16 of n-tuples having the aforementioned entries 22. According to the one embodiment of the invention, the first data structure A′ is additionally provided with two further fields, in which a pointer 10(1) and a pointer 10(2) are provided for each object 16. The pointer 10(1) points to the respective next object 16 in the respective data structure, that is to say in the LIB. In this context, the pointer 10(2) points to the respective preceding object 16 in the LIB. In one embodiment of the invention, the pointers 10(1), 10(2) each comprise four bytes.

Besides the list LIB, another given second data structure B, the “Forwarding Information Base” (FIB for short below) exists, which is likewise implemented in the form of a list and exists for a respective node in the network. It contains entries having information relating to the general destination direction (sink) of a packet (Destination) and relating to the latter's association with a particular Forwarding Equivalence Class FEC, relating to the next hop (NextHop), in the form of an IP address, and relating to the output interface Oif According to one embodiment of the invention, the second data structure B′ comprises a pointer 10(3) in addition to the entries 22 of the given second data structure B. The pointer 10(3) points to the corresponding object 16′ in the LIB.

A fundamental aspect of the solution according to selected embodiments of the invention is the structuring of the information 24 relevant to the forwarding of a packet, so that a very simple change to the data structure, in this case in the form of an extension, permits the use of standard algorithms. This additionally increases the efficiency of the method.

The progression of the proposed method is presented below using the given first and second data structures LIB and FIB which, as described above, are extended.

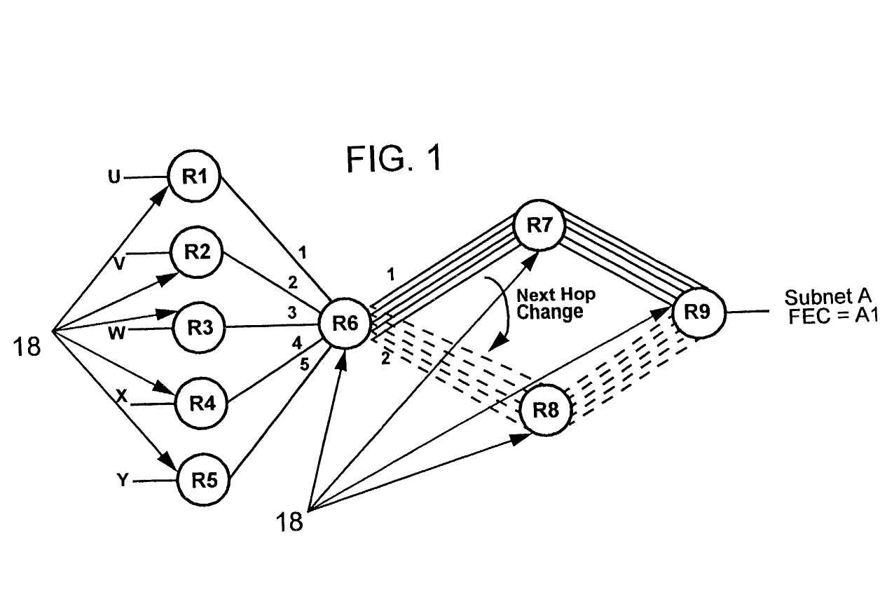

FIG. 1 shows a path change by way of example. In this case, router 6 changes its next hop from router R7 to router R8. The semicircular arrow in FIG. 1, which makes a reference from the total number of paths running via router R7 to the total number of paths running via router R8 (these are shown in dashed lines in FIG. 1), is intended to identify the rerouting of all the paths.

Normally, the FIB and the LIB comprise the path and packet forwarding information illustrated above. According to selected embodiments of the invention, these given first and second data structures A, B are extended by pointers 10(3), 10(1) and 10(2). In this case, the FIB is extended by one pointer 10(3) which makes reference to the corresponding entry in the LIB. The LIB is extended by, preferably, two pointers 10(1) and 10(2), which thus produce a dually interlinked list. On the basis of this extension, customary list administration algorithms known in the prior art can now be used for administering changed path information 24. Although providing this dual interlinking means that the memory space per object 16 is increased in the data structure, and also that the number of necessary steps, in particular attaching pointers, is doubled per basic operation (deletion or insertion of an object 16), the not-to-be-underrated advantage is that the efficiency of the overall method is increased . In addition, it becomes possible to move backward and forward in the list without having to restart the search procedure again. In addition, the search task “find the object before the given object” can be implemented much more efficiently.

Referring to FIG. 2, the extension in this embodiment becomes clear. In the exemplary embodiment shown, all the paths running via the router R7 after the router R6 are intended to be diverted to the router R8. As soon as the router R6 thus changes its “next hop change” from router R7 to router R8, all the paths which previously ran via router R7 need to be transferred uniformly, so that they subsequently run via router R8. In the FIB for node or router R6, two objects 16 are shown, the first relating to the original path via router R7, and the second object 16 relating to the change prescribed by router R6. In response to the change in the list FIB, all the paths which are stored in the list with the path information LIB need to be consistently diverted to router R8. If this example is now used to recall real and hence much more complex lists, the complexity of this search task significantly increases. It is therefore essential to perform this task as quickly as possible. According to a preferred embodiment of the invention, conventional data structures are extended such that algorithms optimized in terms of timing and resources can be used for this task.

By contrast, it has been necessary to date to deal with this task using specific algorithms which, by way of example, have a large number of access operations to individual objects 16 in the data structures and thus had much longer execution times.

All the relevant objects 16 in the table are now sought and changed very efficiently by following the list which starts in the FIB along the pointers 10(1), 10(2) in the LIB in order subsequently to change each object 16 within the respective data structure which previously ran via router R7 and to replace it with an object 16 which runs via router R8. In this context, the backward interlinking in the LIB as a result of the pointer 10(2) additionally speeds up the change operation in this list.

In one alternative embodiment of the invention, the list LIB is extended merely by forward interlinking, namely the pointer 10(1). However, this slows down the method and saves only the additional memory requirement to the extent of 4 bytes in each case, which can be regarded as being little.

A fundamental aspect of the proposed system is that, with a path change, i.e. for example a change to only one node 18 within an MPLS path, all the MPLS-network-relevant information 24 which relates to this node 18 needs to be changed consistently as well. This makes it essential to provide a data structure which allows for this. To this end, only the two pointers 10(1) and 10(2) need to be consistently retraced for all changes in the LIB, in particular insertion or deletion of objects 16. This additional administration complexity is minimal, particularly in relation to the enormously reduced access times.

One advantageous refinement of selected embodiments relates to the conversion of data from conventional first and second data structures A, B into the proposed first and second data structures A′, B′, so that standardized list administration algorithms can be applied for processing the forwarding information 24.

The above description relates to the implementation of the forwarding information 24 in the form of lists and to the extension of the respective data structures (lists) by the entity E in the form of pointers 10(x). However, embodiments which provide another implementation—for example in the form of arrays—having appropriately matched entities E for extending the data structures, for example in the form of additional indices, are certainly within the scope of the invention.

The invention has been described in detail with particular reference to preferred embodiments thereof and examples, but it will be understood that variations and modifications can be effected within the spirit and scope of the invention.

What is claimed is:

1. Data structures for use in a network, comprising:
at least one first data structure having at least one entity per object in addition to routing/forwarding information; and
a second data structure having at least one entity per object in addition to the routing/forwarding information, such that the routing/forwarding information in the first and second data structures is processed using the additional entities.

2. The data structures as claimed in claim 1, wherein
the network is a packet switched network.

3. The data structures as claimed in claim 1, wherein
the network is a multiprotocol label switching network.

4. The data structures as claimed in claim 1, wherein
the first data structure and the second data structure are each implemented as a list having a plurality of entries for each object.

5. The data structures as claimed in claim 1, wherein
the entities are pointers.

6. The data structures as claimed in claim 1, wherein
the first data structure stores a label information base.

7. The data structures as claimed in claim 1, wherein
the second data structure stores a forwarding information base.

8. The data structures as claimed in claim 5, wherein
each object in the first data structure comprises a first pointer and a second pointer, the first pointer pointing to the respectively next object in the first data structure, and the second pointer pointing to the respectively previous object in the first data structure.

9. The data structures as claimed in claim 5, wherein
each object in the second data structure comprises a pointer which refers to a respective corresponding object in the first data structure.

10. A computer assisted method, for processing routing/forwarding information in a network by accessing at least one first data structure having at least one entity per object in addition to routing/forwarding information and a second data structure having at least one entity per object in addition to the routing/forwarding information, comprising:
accessing each object to be processed in the first and second data structures using the additional entities; and
processing the routing/forwarding information using standardized algorithms optimized in terms of timing.

11. The method as claimed in claim 10, wherein:
the routing/forwarding information is split at least over the first data structure and the second data structure,
the second data structure has at least one entity per object, which entity makes reference to a corresponding object in the first data structure.

12. The method as claimed in claim 10, wherein
the standardized algorithms are customary list administration algorithms.

13. The method as claimed in claim 10, wherein the standardized algorithms are DELETE and INSERT algorithms.

14. The method as claimed in claim 10, wherein
the processing of the routing/forwarding information comprises administering changes to the routing/forwarding information.

15. Data structures for a multilayer protocol label switching network, comprising:
a first data structure having a plurality of objects each comprising label information base information and a first routing pointer pointing to the respective next object in the first data structure; and
a second data structure having a plurality of objects each comprising forwarding information base information and a second routing pointer pointing to a corresponding object in the first data structure.

16. A computer assisted method for a multilayer protocol label switching network, comprising:
adding a first routing pointer to label information base information for each object contained in a first data structure, such that each first routing pointer points to a respective next object in the first data structure; and
adding a second routing pointer to forwarding information base information for each object contained in a second data structure, such that each second routing pointer points to a corresponding object in the first data structure.
